(19) United States
(12) Patent Application Publication
(10) Pub. No.: US 2008/0279724 A1
(43) Pub. Date: Nov. 13, 2008

(54) Freshness indicator for beverage and food containers

(76) Inventor: Dana Dicarlo, Baltimore, MD (US)

Correspondence Address: BINGHAM MCCUTCHEN LLP, 2020 K Street, N.W., Intellectual Property Department, WASHINGTON, DC, 20006, US

(21) Appl. No.: 11/797,977

(22) Filed: May 9, 2007

(51) Int. Cl. G01K 13/00

(52) U.S. Cl. 422/58; 215/11.1; 374/150; 422/55

(57) ABSTRACT

Beverage and food containers having a freshness indicator, where the containers include at least one indicator to detect the degree of freshness of the beverage contained therein.

### FIELD OF THE INVENTION

The invention relates generally to freshness indicators for beverage and food containers and, more particularly, to freshness indicators that include at least one measuring device and an output device that indicates visibly and/or audibly when the contents of a container are no longer fresh, for example, on a baby bottle, toddler cup or other container.

### BACKGROUND OF THE INVENTION

Conventional feeding or drinking instruments for babies and toddlers are varied in size and construction. Some are configured to facilitate washing, while others are configured to facilitate holding by the infant or caregiver. Still others are directed to reducing the amount of air trapped in the bottle so as to reduce the amount of air taken in by the infant. For example, U.S. Pat. No. 3,134,494 teaches an infant feeding device designed to prevent the introduction of air into the interior volume as the beverage or liquid food is withdrawn. In addition, baby bottles with a built-in thermometers are known in the art and are generally used as a safety measure or for warming milk. An example of such a bottle design appears in U.S. Design Pat. No. D497,431.

Because babies and toddlers may discard or not completely finish the contents of a bottle or sip or toddler cup, containers designed for their use are often configured to seal or retain the contents under a variety of circumstances for subsequent use of the contents. Some baby bottles are designed with a disk shaped lid that closes the annular opening in the cap and seals the open end of the nipple, which is typically inverted and disposed inwardly. However, this requires handling of bottle parts and opening the bottle to the atmosphere. Likewise, toddler cups have been designed with a spill proof lids for storage and transit.

Similarly, food storage containers typically include a base to store the food and a lid to prevent spillage. For example, disposable plastic containers generally include a base with a cavity for storage and a lid that seals the container to some degree. In addition, plastic storage bags generally include a zipper-type closing to at least partially prevent air or moisture from entering the bag. These containers and bags may also include an area to memorialize the date or contents thereon.

While these prior art designs may be adequate for the basic purpose and function for which they have been specifically designed, i.e., sealing or preventing spillage, they are deficient with regard to their failure to track or notify users of the degree of freshness of the beverage or food contained therein. In fact, the main indication of freshness of a food or beverage is the “sell by” or expiration date imprinted on the beverage or food cartons. Once the beverage or food is taken out of the carton, there is no longer an indicator of freshness. As a consequence, food or beverages past an acceptable degree of freshness may be ingested without knowledge of the lack of freshness. This situation is exacerbated when a container is discarded by an infant or toddler outside of a refrigerated environment. This may lead, for example, to caregivers and/or infants ingesting a beverage that has soured, in the case of milk, or passed its proper degree of freshness, such as a soy milk, formula, or juice.

Accordingly, there remains a continuing need for a freshness indicator for containers that indicates to a user the degree of freshness of the contents of the container. There is a further need for a freshness indicator that is easy to use and that prevents the use of or unnecessary retention of spoiled goods.

### SUMMARY OF THE INVENTION

According to embodiments of the present invention, a freshness indicator may comprise a timer, or a combination of a timer and thermometer, that may be implemented on a container when it is filled and sealed and that audibly and/or visually notifies the user when the contents of the container are no longer fresh. The freshness indicator may be integrated into a container or the seal of a container, or may be separately distributed for affixation to a variety of containers in a variety of ways. There are various embodiments of the indicator. According to one embodiment, an audible alarm may be set that goes off after a predetermined time interval to signify to a parent or a child that the contents of the container have spoiled and should not be consumed.

### BRIEF DESCRIPTION OF THE DRAWINGS

The above described features and advantages of the present invention will be more fully appreciated with reference to the detailed description and Figures, in which:

FIG. 1 depicts an illustrative container according to the prior art.

FIG. 2 depicts an illustrative toddler drinking cup according to the prior art.

FIG. 3 depicts an illustrative container for a baby with a freshness indicator according to an embodiment of the present invention.

FIG. 4 depicts an illustrative container for a baby with a freshness indicator affixed according to another embodiment of the present invention.

FIG. 5 depicts an illustrative container for a baby with a freshness indicator affixed according to still another embodiment of the present invention.

FIG. 6 depicts an illustrative time configuration according to an embodiment of the present invention.

FIG. 7 depicts a functional block diagram of a timer and temperature sensor device according to an embodiment of the present invention.

FIG. 8 depicts a flow chart of the operation of a timer and/or temperature sensor device according to an embodiment of the present invention.

FIG. 9 depicts a cross sectional view of an illustrative beverage container having an activation circuit and a timer and/or temperature device coupled to the container according to an embodiment of the present invention.

### DETAILED DESCRIPTION OF THE INVENTION

According to embodiments of the present invention, a freshness indicator may comprise a timer, or a combination of a timer and thermometer, that may be implemented on a container when it is filled and sealed and that audibly and/or visually notifies the user when the contents of the container are no longer fresh. The freshness indicator may be integrated into a container or the seal of a container, or may be separately distributed for affixation to a variety of containers in a variety of ways. Below container and freshness indicator implementations and their use according to various embodiments of the invention are described.

### The Container

A container for use with the present invention can be any beverage or food container. In particular, the containers of the present invention generally include a base and a lid, i.e., sealable containers. For example, the container may be a plastic, rubber or glass storage container for food or beverages, including disposable and non-disposable plastic food or beverage storage containers with bases or cavities for the food or beverage and lids that seal out at least a portion of the surrounding air or moisture. Containers according to embodiments of the present invention generally have a body and a lid, where the lid may or may not include a passage through which to dispense the contents. The lid or body when closed may seal the container, which is a conventional feature of may containers, though the seal does not need to be complete, nor is sealing a necessary feature of the invention, even though it is desirable for a number of implementations.

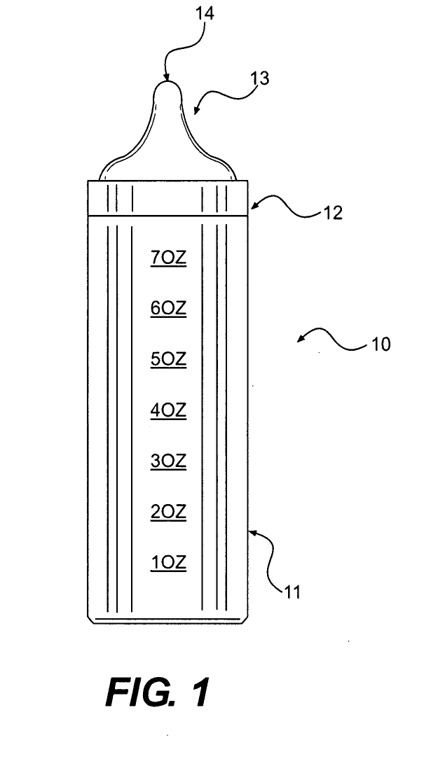

An example of a suitable container according to an embodiment of the invention is a bottle-type device for feeding an infant. In this aspect of the invention, the bottle, shown generally at 10 in FIG. 1, includes a main body 11 and an open top end 12 through which the bottle is filled with a beverage. A conventional nipple assembly 13 is mounted to the open top end 12, which includes an aperture 14 through which liquid can be drawn from. Various bottle designs may be used with embodiments of the invention, including those disclosed and shown in U.S. Pat. Nos. 6,786,344, 6,116,439, and 6,786,345, the entire disclosures of which are incorporated by reference herein.

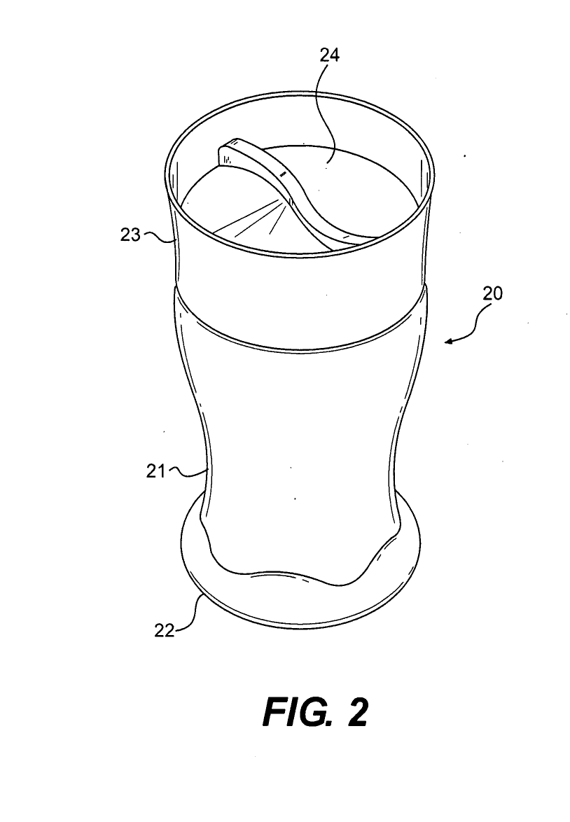

In another embodiment, the container may be a toddler drinking cup. Any toddler drinking cup may be used. However, to facilitate description, an illustrative toddler drinking cup is shown in FIG. 2. Referring to FIG. 2, the container 20 may have a substantially cylindrical shape that includes a main body 21, base 22, and top 23 that includes lid 24. For example, U.S. Pat. No. 6,783,020, the entire disclosure of which is incorporated by reference herein, describes a toddler cup used for children to transition them from a sip cup to a conventional drinking cup.

In yet another embodiment, the container is a combination bottle-type device and toddler cup. For example, U.S. Design Pat. Nos. D464,139 and D470,593 show a suitable container for use with the present invention, the entire disclosures of which are incorporated by reference herein. In particular, a combination bottle-type device and toddler cup may include a main body, an open top, and interchangeable lids for bottle-type drinking, i.e., with a nipple attachment, or sip cup drinking, i.e., with a screw or push top lid that has several apertures from which liquid can be drawn.

The container may be made from a variety of materials, including opaque, transparent or translucent plastics, rubber and/or glass. In one embodiment, the container may be formed from a material including polystyrene, polystyrene-acrylonitrile, acrylonitrile-butadiene-styrene, styrene-maleic anhydride, polycarbonate, polyethylene terephthalate, polyvinylcyclohexane, and combinations thereof. In another embodiment, the container is formed at least in part from a material including homopolymer or copolymer thermoplastic materials. Nonlimiting examples of such materials include polyethylene, polypropylene, high and low density polyethylene, linear low density polyethylene, and combinations thereof. As those of ordinary skill in the art will appreciate, the various parts of the container may be formed from different materials or the same materials depending on the container and the design thereof.

As known to those of ordinary skill in the art, when some beverages or foods are exposed to light, the light causes aroma and flavor defects. For example, when milk is exposed to light, aroma and favor defects may result at least partially because vitamins B and C, which are responsible for the rancid flavor in milk, are degraded upon exposure to light. As such, a container according to one embodiment of the invention does not transmit light or limits the transmission of light.

The container may be blow-molded or molded through other appropriates methods known to those of ordinary skill in the art.

### The Freshness Indicator

Affixation or Attachment of the Freshness Indicator

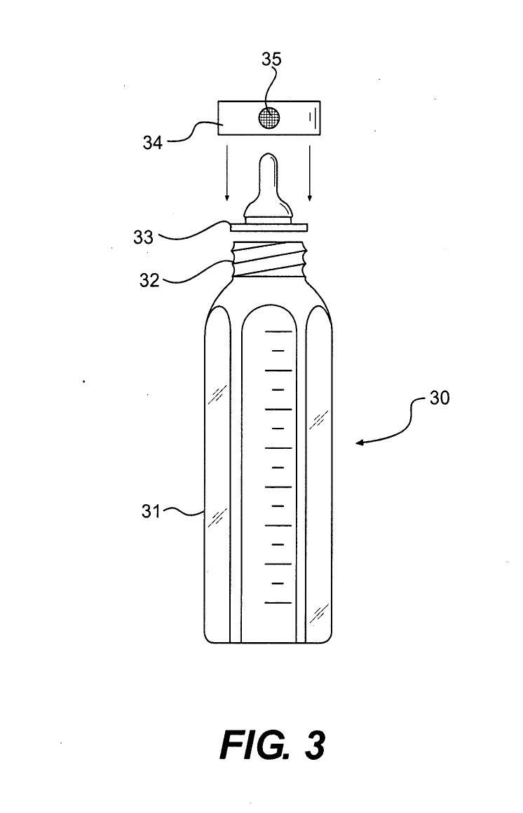

The freshness indicator may be coupled a container, such as those discussed above in a variety of ways. When the container is a bottle-type feeding device, the freshness indicator may be part of the collar that connects the main body of the container to the nipple. For example, as shown in FIG. 3, a bottle 30 according to the invention has a main body 31 with an open end 32, a detached nipple 33, and a collar 34. The collar 34 fits over the nipple 33 to secure the nipple to the open end 32. The freshness indicator 35 is located in the collar 34.

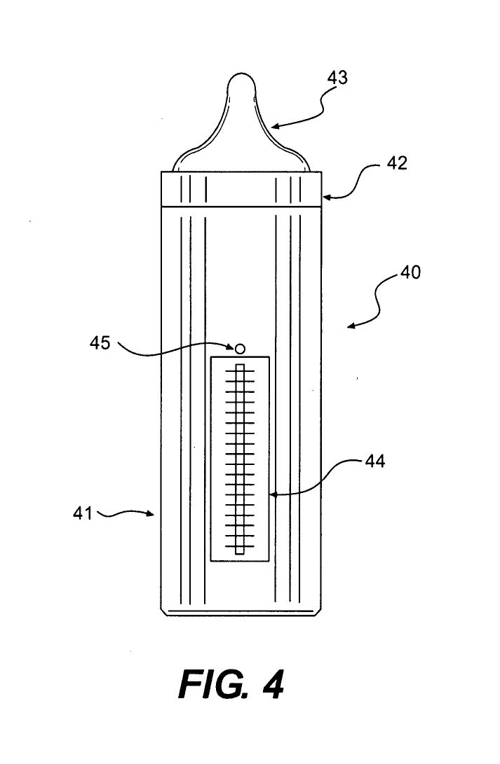

In another embodiment, the freshness indicator is integrated within or affixed to the container. An example of this embodiment is generally shown in FIG. 4. In particular, the bottle 40 includes a main body 41, a collar 42, and a nipple 43. The freshness indicator 44 is affixed to the bottle-type feeding device or molded as part of the bottle-type feeding device. The affixation method can vary and includes the use of adhesive, epoxy, or a mechanical coupling, including a strap, snap, détente, hooks and loops such as those that form the fastener VELCRO or any other convenient fastener. The examples of FIGS. 3 and 4 show that, according to embodiments of the present invention, the freshness indicator can be integrated within the body or lid of a container, or affixed to the body or lid of the container.

The freshness does not have to be permanently affixed to the container and, by contrast, may be removably affixed or attached to the container to permit the use of the freshness indicator with more than one container. Any method of removable attachment may be used, including adhesive, magnetic attachment, or mechanical attachment including by a strap, tether, snap, détente, or hooks and loops such as those that form the fastener VELCRO, or any combination thereof.

Timer

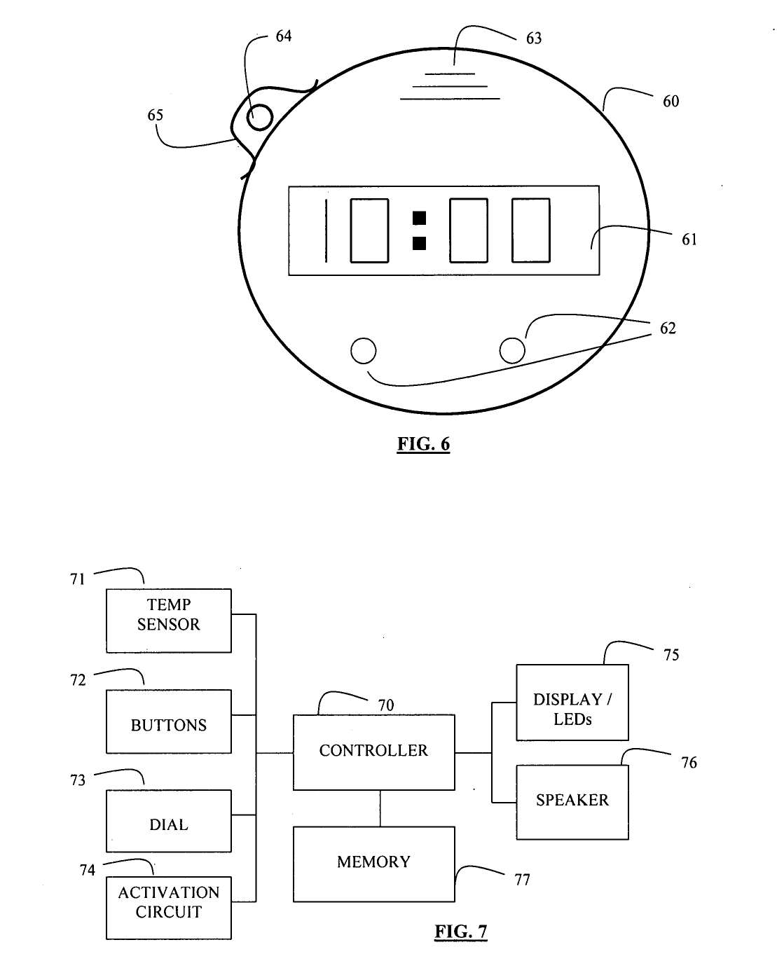

In one embodiment, the freshness indicator may be implemented as an analog or digital timer. An illustrative timer 60 is shown in FIG. 6, and may include a display 61, buttons or other inputs 62, a speaker 63 and optionally a tab 65 with a hole 64 for tethering the timer to a container. As an alternative to tethering, the timer may have adhesive or a fastener such as Velcro for adhering the timer to the container or may be mounted in the container walls or a lid.

The timer may several modes, including an inactive mode, a programming mode, an active timer mode, and an expired mode that indicates the lack of freshness of the beverage or food contained in the container. In the active timer mode, the timer may count down an interval of time until the time interval expires. The time interval may be pre-programmed for a particular type of contents, such as milk, or may be set by the user. In the expired mode, the timer may output a visible or audible alarm indicating to the user the expiration of the freshness period. The programming mode may allow the user to program a variety of information into the timer, depending on the implementation, including the type of alarm, time interval, type of contents in the container, time of day, day of the week, and any other convenient information.

As shown, the timer may include one or more input buttons 62 and a speaker 63 and/or display 61. The display may be any type of display capable of being implemented in a small form factor, such as a LED, LCD or any other type of small size display. The button or buttons may be used to control the various modes. In one embodiment, an activator button may be depressed to set a time interval and activate the timer. This may be accomplished in a variety a ways, including by depressing the button until a number of beeps corresponding to a number of hours is heard. A second depression of the button may then initiate the timer. The time period is one that the user selects to correspond to a freshness period of the contents of the container. During use, when the selected freshness period expires, the user is alerted via the visible or audible indicating device 45.

In another embodiment, the activator button or switch may have at least one time interval associated therewith. In this aspect of the invention, the button may initiate the active mode for the selected time interval. In yet another embodiment, shown generally in FIG. 4, the activator is in the form of a sliding scale. For instance, activator 44 may include various selections for freshness periods that correspond to predetermined count values. Once the selected freshness period expires, the visible or audible indicating device 45 alerts the user.

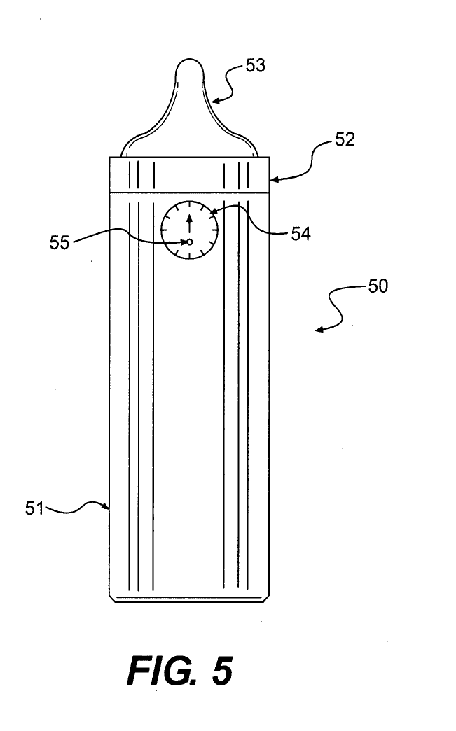

In yet another embodiment, the activator is a dial with at least one time interval associated therewith, as shown generally in FIG. 5. In this regard, a dial 54 initiates the active mode for the selected time interval. Once the selected freshness period expires, the visible or audible indicating device 45 alerts the user.

The selected time interval may vary depending on the type of container, type of beverage or food intended to be stored therein, or storage conditions. For example, when the container is a baby bottle, the selected time interval may correspond to manufacturer or FDA instructions for freshness of formula, breast milk, soy milk, or cow milk. In addition, the selected time interval may vary depending on the storage conditions, i.e., ambient temperature, sub-ambient temperature, and the like. As such, the time interval(s) appearing on the activator may range from minutes to several days or longer depending on the type of food or beverage contained therein.

According to one embodiment, an audible alarm may be set in any convenient manner that goes off after a predetermined time interval to signify to a parent or a child that the contents of the container have spoiled and should not be consumed.

In still another embodiment, the timer may be activated not by the user pressing a button, but rather through the user's properly sealing the container. For example, the container may include a button or electrical connection which is depressed or completed, respectively, when the container is properly closed or sealed. In another embodiment, the container may include a sealing member, such as that disclosed in U.S. Pat. No. 6,401,949, the entire disclosure of which is incorporated by reference herein. When the container is a bottle-type feeding device or toddler cup, the sealing member is preferably disposed between the nipple or dispensing member, respectively, and the open end of the container. Regardless of the type of seal, once the seal is intact, the active mode of the timer may be automatically or separately initiated. After a predetermined, programmable “time-out”, the timer enters the expiration mode and the visible or audible indicating device alerts the user that the beverage has lost its freshness.

The freshness indicator may also include a display, such as an LED, to show a variety of information, including the time interval programmed or time remaining, in a simple implementation. In more complex implementations, the display may show information about: mode, programming, temperature of the contents, seal, the type of contents of the container, calendar information, timer interval or intervals, seal information, or any other information corresponding to freshness or programming or measuring freshness. In still other implementations, the display or LED may simply light up or flash as a form of alarm or signal to the user that the freshness period has expired or been reached.

In implementations where the freshness indicator is electrically connected to the container seal, the timer may indicate through the display or audibly that a proper seal is created once the container is properly closed both to prevent leaks out of the container and to prevent air from entering the container. For example, the timer may illuminate the display, or display visual or audible message to indicate a proper seal. In addition, if the seal is imperfect, the indicator may provide an audible or visible warning to the user, or the timer may simply not allow itself to go into the active mode.

Timers capable of being programmed and used according to the embodiments of the present invention may be implemented in a variety of well known techniques using readily available technology. In an alternate embodiment, the activator may be located in a remote transmitter that has various input parameters including the time interval for active mode. In this regard, the remote transmitter may send an activation signal to the freshness indicator on the container.

An illustrative embodiment of a freshness indicator is shown in FIG. 7. Referring to FIG. 7, the freshness indicator 70 has a controller 70 that includes or is coupled to memory 77. The controller may also be coupled to inputs, including one or more buttons 72 or knobs or dials 73, a temperature sensor 71 and/or an activation circuit 74 that detects when a proper seal has been made for a container, and outputs including a display 75 and/or a speaker 76. The controller may receive input signals from the buttons and activator and may also provide output signals including time information, programming information or alarm signals to the display and/or speaker.

FIG. 9 depicts an illustrative cross section of a container including an activator circuit coupled to a freshness indicator device according to an embodiment of the present invention. Referring to FIG. 9, the container includes a container body 90 and a lid 91. The container body includes a threaded portion that mates with a hollow portion of the lid 96. At an upper portion of the container body 90 adjacent to the threaded portion are metal contacts 92 and 93 that form part of an activation circuit. The container further includes a timer 98 mounted to the container that has inputs coupled to the contacts 92 and 93 via wires 94. The lid 91 includes a contact 95 that is formed at the lower portion of the lid and is disposed about the periphery of the lid. When the lid 91 is screwed onto the container body 90 and sealed, the contact 95 connects the contacts 92 and 93 forming a closed circuit indicating that a seal has been made.

The controller may be implemented as a microprocessor that operates in accordance with instructions and data provided by the memory 77. For example, if the activator is in the form of a button to depress, the controller can create a count value that corresponds to the time interval that the button is depressed. The controller may either count up to the count value or count down from the count value. Once the count value reaches expiration, the controller may send a signal to the indicator. In one embodiment, the controller may send a first signal to the indicator at a predetermined interval prior to the expiration of the count value in order to warn the user of the impending expiration of the freshness period and send a second signal to the indicator at the expiration of the count value.

Although a microprocessor is described, those of ordinary skill in the art will appreciate that the controller may be replaced by a counter and associated circuits. In another embodiment, the controller and memory may function as a speech synthesizer that drives the speaker to generate pre-programmed speech or noises.

The freshness indicator preferably operates on battery power that provides power to the printed circuit board assembly and timing apparatus. In an alternate embodiment, the freshness indicator may operate on solar power.

Temperature Sensor

The freshness indicator of the present invention may includes a temperature sensor that detects non-optimal temperatures of the beverage or food in the container. For example, the temperature sensor may function with a user input value, i.e., a pre-determined temperature above or below which the beverage or food is of acceptable quality, or with a value preprogrammed into the timer, such as a temperature below which milk spoils.

The user may input a temperature value through an input, such as buttons, a knob or dial, sliding scale or the like. When the input values are predetermined values appearing on the activator for selection by the user, the input values may be based on the type of container, type of beverage or food intended to be stored therein, or optimal storage conditions. For example, manufacturer or FDA guidelines may be taken into consideration when selecting the input values.

The temperature sensor is coupled to the controller and configured to convey the temperature of the beverage or food in the container to the controller. The controller may be programmed to use the temperature sensor to provide output signals to the display or speaker based on the temperature indicated by the temperature sensor. In this regard, the device may provide a visible or audible warning if the temperature is above or below a user input value or a predetermined value. In another embodiment, the indicating device may actually show the temperature of the beverage or food in the container and also provide a visible or audible warning if the temperature is above or below the user input value. The temperature sensor may also have a separate housing from the timer device in some embodiments and an indicator device separate and distinct from the timer device, or alternatively, the temperature sensor and timer device share a housing and use the speaker and/or display. The temperature sensor may also provide continuous temperature readings to the controller which may use those readings in determining freshness of the contents of a container that is based on time and temperature of the contents, and the optionally also type of contents.

While the description herein focuses on a temperature sensor that is integral to the freshness indicator, those of ordinary skill in the art will appreciate that the containers of the invention may have a separate and distinct temperature sensor. That is, a thermometer may be built in to the container as shown in U.S. Design Pat. No. D497,431 or may be affixed to the container via methods known to those of ordinary skill in the art. In this aspect, the thermometer may be on the opposite side of the container as the freshness indicator. For example, the bottle 40 shown in FIG. 4 may include a freshness indicator 44 on one side and a thermometer (not shown) on the opposite side of the bottle.

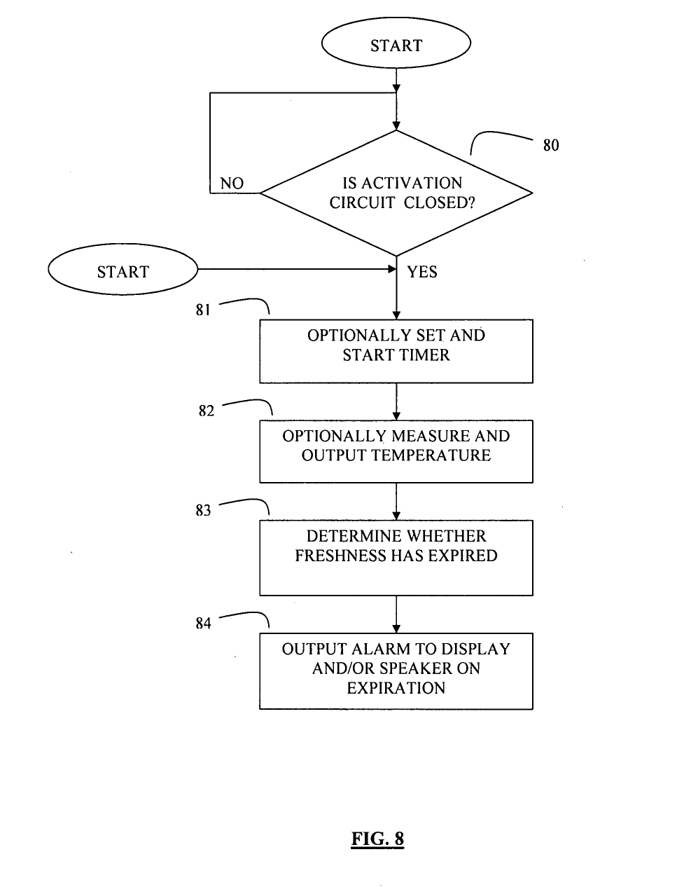

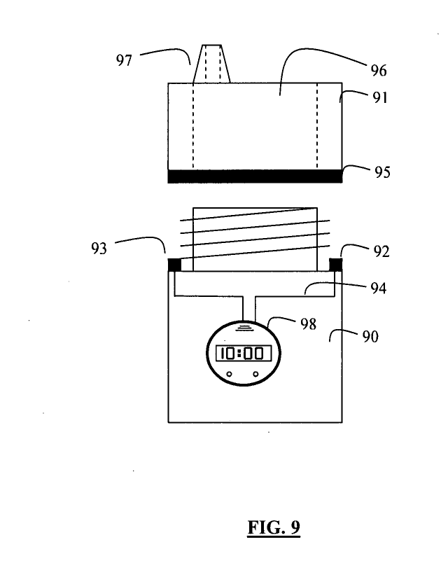

FIG. 8 depicts an illustrative method according to an embodiment of the present invention. Referring to FIG. 8, there are two points at which the method may start. When an activation circuit is present, the method may start with step 80, which detects whether or not the activation circuit is closed and thus the container has been closed and sealed. If yes then step 81 begins. If not, then the method does not proceed further.

Step 81 may begin after the activation circuit is closed or, if there is no activation circuit, may be initiated by a user. In step 81, the timer may be set or programmed by a user and started using the buttons or other inputs to the freshness indicator. Alternatively, the timer may be automatically started in step 81 after the activation circuit is closed, depending on the programming of the freshness indicator.

In step 82, if a temperature sensor is present and coupled to the freshness indicator, the controller within the freshness indicator may measure and store the temperature from the temperature sensor in memory and use the temperature to determine the freshness interval or whether to output an alarm to the display or speaker.

In step 83, the freshness sensor determines whether the freshness of the contents of the container have expired. This determination is made as a function of the timer and optionally the temperature sensor and type of contents, for example milk, within the container. Any suitable formula may be used from a simple timer to a more complex algorithm that takes into account temperature.

In step 84, once the freshness has expired, the freshness indicator outputs an alarm signal to the speaker and/or display to warn a user that the freshness of the contents of the container has expired.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. For example, while examples in the description above generally relate to baby bottles and toddler cups, the invention also contemplates various types of storage containers for beverages and foods. Such modifications are also intended to fall within the scope of the appended claims. All patents and patent applications cited in the foregoing text are expressly incorporate herein by reference in their entirety.

What is claimed is:

1. A freshness indicator for a food or beverage held in a container, comprising:
a user-configurable timer; and
an indicating device coupled to the timer and configured to indicate to a user an expiration of the freshness of contents of the container, based on the timer;
wherein the timer is attachable to the container.

2. The freshness indicator of claim 1, wherein the freshness is indicated based on the elapsing of a predetermined interval.

3. The freshness indicator of claim 1, wherein the indicating device is a display.

4. The freshness indicator of claim 1, wherein the indicating device is a speaker.

5. The freshness indicator of claim 1, wherein the indicating device is a light emitting diode.

6. The freshness indicator of claim 1, wherein the timer is attachable to the container using a clip.

7. The freshness indicator of claim 1, wherein the timer is attachable to the container using an adhesive.

8. The freshness indicator of claim 1, wherein the timer is attachable to the container using a strap that is placed around the container.

9. The freshness indicator of claim 1, further comprising a temperature sensor, wherein the timer is coupled to the temperature sensor and is configured to indicate through the indicator device to a user a status associated with the temperature of the container.

10. The freshness indicator according to claim 1, wherein the indicator device includes a speaker and a display.

11. The freshness indicator of claim 1, further comprising a temperature sensor, wherein the timer is coupled to the temperature sensor and further determines the freshness based on the temperature indicated by the temperature sensor.

12. A container, comprising:
a lid;
a body for holding a food or a beverage or a food; and
a freshness indicator connected to the container, wherein the freshness indicator includes a user-configurable timer and a first indicating device coupled to the timer configured to indicate to a user a freshness of the contents of the container based on the timer.

13. The container of claim 12, wherein the container is a baby bottle.

14. The container of claim 12, wherein the container is a sippy cup.

15. The container of claim 12, wherein the container is a food storage container.

16. The container of claim 12, wherein the freshness indicator further comprises a temperature sensor coupled to the timer and wherein the freshness is further determined based on the output of the temperature sensor.

17. The container of claim 12, wherein the freshness indicator is built into the lid.

18. The container of claim 12, wherein the freshness indicator is built into the body.

19. The container of claim 12, further comprising an activator circuit coupled to the lid, body and timer that is activated when the lid and body of the container are properly sealed.

20. A method for indicating the freshness of a food or beverage held in a container, comprising the steps:
starting a timer attached to a container;
determining whether the freshness of the contents of the container has expired based on the timer; and
outputting an alarm when the freshness has expired.

21. The method of claim 17, further comprising the step of:
monitoring a temperature;
wherein the determining includes determining whether the freshness of the contents of the container has expired based on the temperature and the timer.

22. The method of claim 17, further comprising:
displaying a time associated with the timer; and
setting the timer.

23. The method of claim 17, further comprising:
generating an alarm when the temperature exceeds a predetermined value.

24. The method of claim 17, further comprising:
displaying the temperature.

25. The method of claim 17, further comprising:
attaching the timer to the container.

26. The method of claim 17, further comprising:
determining whether the container has been properly sealed.

27. The method of claim 23, further comprising:
displaying to the user that the container has been properly sealed.
